(19) United States
(12) Patent Application Publication
(10) Pub. No.: US 2014/0242363 A1
(43) Pub. Date: Aug. 28, 2014

(54) Durable, Germicide-Free and Antibacterial Coating

(71) Applicant: Nano and Advanced Materials Institute Limited, Hong Kong (HK)

(72) Inventors: Ngar Yee HUEN, Hong Kong (HK); Connie Sau Kuen KWOK, Hong Kong (HK); Wing Kei HO, Hong Kong (HK); Peter Wai Man LEE, Hong Kong (HK)

(73) Assignee: Nano and Advanced Materials Institute Limited, Hong Kong (HK)

(21) Appl. No.: 14/142,937

(22) Filed: Dec. 30, 2013

Related U.S. Application Data
(60) Provisional application No. 61/850,900, filed on Feb. 26, 2013.

(51) Int. Cl. C09D 5/14

(52) U.S. Cl. CPC C09D 5/14
USPC 428/216; 106/18.32; 427/384

(57) ABSTRACT

The presently claimed invention provides a coating solution for an antibacterial coating, and a method for synthesizing the coating solution. The coating solution comprises ethanol, nitric acid, titanium tetraisopropoxide, water, and silver nitrate. Furthermore, a coating method for deposition of the antibacterial coating is also provided. The antibacterial coating of the present invention is effective in providing antibacterial function, easy to be manufactured, and durable.

### CROSS REFERENCE TO RELATED APPLICATION:

Pursuant to 35 U.S.C. §119(e), this is a non-provisional patent application which claims benefit from U.S. provisional patent application Ser. No. 61/850,900 filed Feb. 26, 2013, and the disclosure of which is incorporated herein by reference.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to a coating, and particularly relates to a durable, germicide-free and antibacterial coating. The present invention also relates to a coating solution and preparation method for forming said coating.

### BACKGROUND

An antibacterial coating basically contains an antibacterial agent that inhibits or reduces the ability of bacteria to grow on the surface of the coating. Such coating is getting widely used in various areas including clinics, industry, and even home. One of the most commonly used areas with antibacterial coatings is in clinic or hospital since the antibacterial coatings are able to reduce the risk of disease transmission.

It is well known in the art that titanium dioxide and silver are commonly used to form antibacterial coatings. US2010/0062032 discloses a doped titanium dioxide coating for antimicrobial coatings, and the preferred dopants are silver and silver oxide.

US2011/0111213 also discloses a silver (Ag)-ion containing titanium (Ti) oxide coating having a silver content of greater than or equal to 0.2 of Ag/1 of Ti to less than or equal to 0.4 of Ag/1 of Ti, wherein the coating is X-ray amorphous and the hydrophobicity of the coating can be reduced persistently by illumination. A process for producing the coating comprises the steps of preparing a TiO₂—Ag solution, coating a carrier material using the TiO₂—Ag solution, and curing the coating that has been applied to the carrier, using a temperature equal or less than 200° C.

EP1681325 discloses a coating material which comprises titanium dioxide as a photocatalyst, apatite comprising calcium phosphate for adsorbing contaminants, a polymethoxy polysiloxane as a hydrophilic resin coating material, and also a thiosulfato silver complex as an antibacterial material. The coating formed by the coating material can convert pollutants such as various bacteria to harmless materials.

Nevertheless, the coatings from the abovementioned prior arts involve complicated process in synthesis of the coating solution. The synthesis of these conventional coatings requires elevated temperature to cure the coating solution. In addition, some coatings from the prior arts fail to provide coatings with high transparency, which limits the application of coating. Furthermore, these conventional coatings are easily peeled off after a period of usage, ultimately losing their functions.

Consequently, there is an unmet need for antibacterial coatings which are effective in providing antibacterial function, easy to be manufactured, and durable.

### SUMMARY OF THE INVENTION

Accordingly, a first aspect of the presently claimed invention is to provide a coating solution for an antibacterial coating.

In accordance with an embodiment of the presently claimed invention, the coating solution comprises ethanol, nitric acid, titanium tetraisopropoxide, water, and silver nitrate, where the concentration of silver nitrate is 0.025%-0.25% (w/v).

A second aspect of the presently claimed invention is to provide a method for synthesizing a coating solution for an antibacterial coating.

In accordance with an embodiment of the presently claimed invention, the method for synthesizing a coating solution comprises steps of hydrolyzing titanium (IV) isopropoxide into water with addition of nitric acid to form white precipitates, stirring the white precipitates to obtain a semi-transparent titanium dioxide (TiO₂) solution with a first pH from 1 to 2, putting the TiO₂ solution into a porous dialysis membrane tube, dialyzing the TiO₂ solution in water until a second pH of the TiO₂ solution reaches between 3 and 4 to form a first solution, dissolving silver nitrate into water to form a second solution, and mixing the first solution, the second solution and ethanol together to form the coating solution. The resulting coating solution according to this embodiment may comprise 0.025%-0.25% (w/v) of silver nitrate.

A third aspect of the present invention is to provide a coating method for deposition of an antibacterial coating.

In accordance with an embodiment of the presently claimed invention, the coating method for deposition of an antibacterial coating comprises steps of preparing the coating solution of the presently claimed invention, providing an object; applying the coating solution onto at least a surface of the object to form one or more coating layers; and drying the one or more coating layers with a curing temperature in a range from 80 to 300° C. at a drying rate. The drying rate may be 4-30 minutes per layer; the number of the coating layers is in a range of 2 to 10; each of the one or more coating layers has a thickness from 0.5 to 5 μm.

Unlike the traditional antibacterial coatings, the antibacterial coating of the presently claimed invention provides several advantages. The antibacterial coating of the present invention is effective in removal of bacteria and microorganisms, and easy to be applied on various objects due to its low curing temperature and high drying rate. Additionally, the antibacterial coating is durable because of its high hardness and strong adhesion property. The antibacterial coating of the present invention is high in transparency since the formed TiO₂ solution is semi-transparent, and only thin coating is required but good enough to perform antibacterial function.

### BRIEF DESCRIPTION OF THE DRAWINGS

Embodiments of the present invention are described in more detail hereinafter with reference to the drawings, in which:

FIG. 1 is a flowchart illustrating steps of a method for synthesizing a coating solution for an antibacterial coating according to an embodiment of the presently claimed invention;

FIG. 2 is a flowchart illustrating steps of a coating method for deposition of an antibacterial coating according to an embodiment of the presently claimed invention;

FIG. 3A-B shows scanned electron microscopy (SEM) morphologies of an antibacterial coating before and after rubbing with a diluted bleach solution according to an embodiment of the presently claimed invention;

FIG. 3C is a graph showing the relationship between the atomic concentration of silver before and after rubbing with the diluted bleach solution;

FIG. 4 is a graph showing numbers of an event that the numbers of total bacteria colonies on non-coated keys were higher that of coated keys, and other event that the numbers of total bacteria colonies on coated keys were higher or equal to non-coated keys;

FIG. 5A-B shows SEM morphology and titanium mapping of an antibacterial coating according to an embodiment of the presently claimed invention; and

FIG. 5C-D shows SEM morphology and titanium mapping of an antibacterial coating according to another embodiment of the presently claimed invention;

FIG. 6 shows appearances of keys of a keyboard with the antibacterial coatings with different percentages of Ti concentration including 1%, 2.5%, 5%, and 10% (v/v) according to various embodiments of the presently claimed invention; and

FIG. 7 shows SEM morphology of an antibacterial coating with ten coating layers according to one embodiment of the presently claimed invention.

### DETAILED DESCRIPTION OF PREFERRED EMBODIMENTS:

In the following description, a coating solution for an antibacterial coating, a method for synthesizing the coating solution, and a coating method for deposition of the antibacterial coating are set forth as preferred examples. It will be apparent to those skilled in the art that modifications, including additions and/or substitutions, may be made without departing from the scope and spirit of the invention. Specific details may be omitted so as not to obscure the invention; however, the disclosure is written to enable one skilled in the art to practice the teachings herein without undue experimentation.

According to an embodiment of the presently claimed invention, a coating solution for a durable, germicide-free and antibacterial coating comprises ethanol, nitric acid, titanium tetraisopropoxide, water, and silver nitrate. Preferably, the coating solution comprises 0.025%-0.25% (w/v) of silver nitrate. More preferably, the coating solution comprises 0.1% (w/v) of silver nitrate. In another embodiment, the coating solution also comprises 1%-10% (v/v) of titanium tetraisopropoxide.

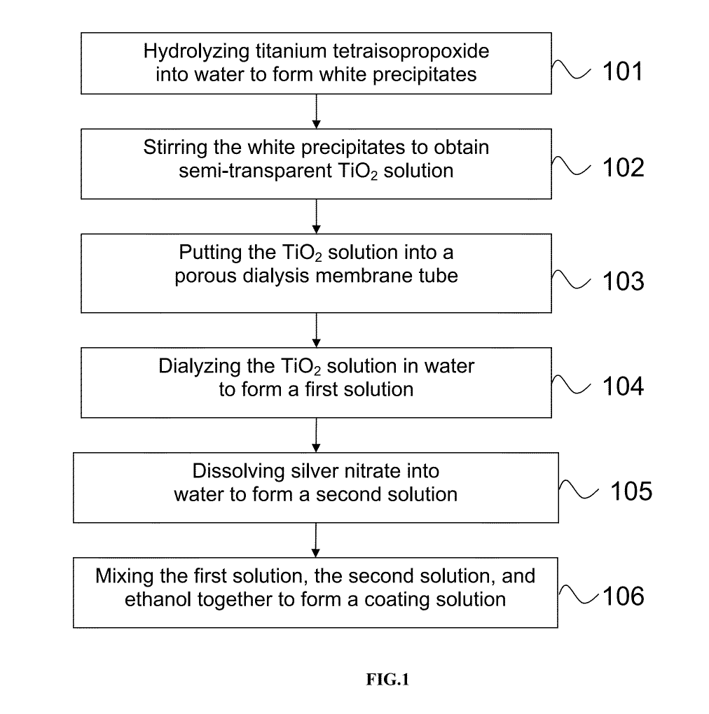

FIG. 1 is a flowchart illustrating steps of a method for synthesizing a coating solution for an antibacterial coating according to an embodiment of the presently claimed invention. In step 101, titanium (IV) isopropoxide is hydrolyzed into water with addition of nitric acid to form white precipitates. In step 102, the white precipitates are stirred to obtain a semi-transparent TiO₂ solution with a pH from 1 to 2. In step 103, the TiO₂ solution is put into a porous dialysis membrane tube. In step 104, the TiO₂ solution is dialyzed in water until a pH of the TiO₂ solution reaches between 3 and 4 to form a first solution. In step 105, silver nitrate is dissolved into water to form a second solution. In step 106, the first solution, the second solution, and ethanol are mixed together to form the coating solution.

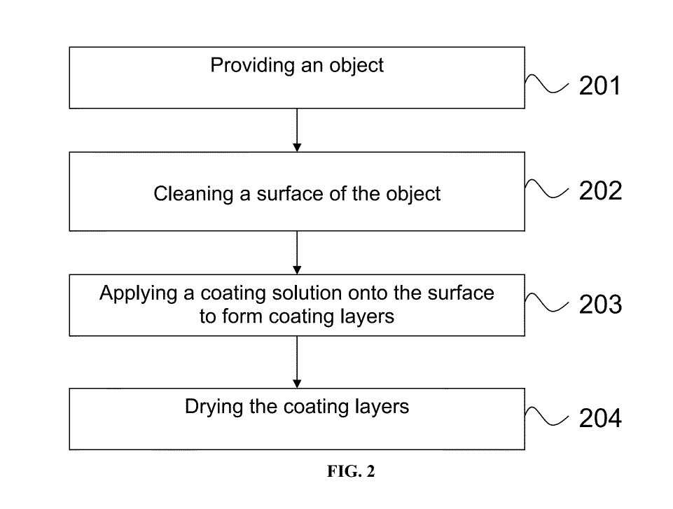

FIG. 2 is a flowchart illustrating steps of a coating method for deposition of the antibacterial coating according to an embodiment of the presently claimed invention. In step 201, an object is provided. In step 202, at least a surface of the object is cleaned by alcohol or water. In step 203, the coating solution of the present invention is applied onto the at least a surface of the object to form one or more coating layers. In step 204, the one or more coating layers is/are dried with a curing temperature at a drying rate.

Preferably, in step 203, the coating solution can be applied onto the surface of the object by a spraying method, a spreading method, or a dipping method.

According to an embodiment of the presently claimed invention, the object is sprayed with the coating solution by a spray gun from left to right, and then up to down to form the one or more coating layers.

Preferably, the number of the coating layers on the at least a surface of the object is in a range from 2 to 10. The thickness of each coating layer is between 0.5 and 5 μm.

In step 204, the one or more coating layers can be dried in an oven. Preferably, the curing temperature is in a range form 80 to 300° C., and the drying rate is 4-30 minutes per coating layer. Optionally, after curing the last coating layer, additional drying with extra drying time is employed to ensure complete curing of the coating layers.

According to an embodiment of the presently claimed invention, the drying time for each coating layer is 4 minutes. In an example of employing two coating layers, it is optional to have an additional drying time of 26 minutes to ensure complete curing after curing the last coating layer. Total drying time for multiple layers, without additional drying and with additional drying, is listed in Table 1 as follows:

TABLE 1

| Number of | Total drying | Total drying time with |
|---|---|---|
| coating layer | time | additional drying |
| 2 | 8 | 34 |
| 6 | 24 | 50 |
| 10 | 40 | 66 |

### EXAMPLE 1

A coating solution is prepared to form an antibacterial coating. The chemicals, their corresponding volume used and percentage by volume in the coating solution are listed in the table 2:

TABLE 2

| Chemicals | Volume | | Composition |
|---|---|---|---|
| Absolute ethanol (≧99%) | 80 | ml | 57.1% |
| Nitric acid (65%) | 0.4 | ml | 0.29% |
| Titanium tetraisopropoxide (TTIP) | 3.6 | ml | 2.60% |
| (97%) | | | |
| DI Water | 53.33 | ml | 38.0% |
| Silver nitrate (0.3M) (≧99%) | 2.67 | ml | 2.0% |
| Total | 140 | ml | 100% |

Accordingly, 2.67 ml of silver nitrate (0.3M) in said coating solution corresponds to 0.1% of silver nitrate (w/v).

A method for synthesis of the coating solution is shown as follows. 50 mL of titanium(IV) isopropoxide (TTIP) is hydrolyzed into 500 mL deionized (DI) water with addition of 5 mL of nitric acid to form white precipitates. The white precipitates are stirred at room temperature for 72 hours to obtain a semi-transparent TiO₂ solution with pH 1-2. 50 mL TiO₂ solution is put into a porous dialysis membrane tube. The TiO₂ solution is dialyzed in 500 mL DI water for 4 hours, and the DI water is changed every hour until pH of the TiO₂ solution reaches 3-4 to form a first solution. 0.136 g of silver nitrate is dissolved into 20 mL of DI water to form a second solution. 40 mL of the first solution, 20 mL of the second solution, and 80 mL of ethanol are mixed together to form the coating solution.

Several tests were conducted with the antibacterial coating formed from the coating solution of Example 1.

The adhesion property of the antibacterial coating was evaluated following ASTM D3359 standard. The adhesion test was performed with the antibacterial coating of one coating layer, and three sets of experiment were conducted. The results, as shown in Table 6, indicate that the adhesion of the antibacterial coating is 3B.

TABLE 6

| | Number of | | | | |
|---|---|---|---|---|---|
| Sample | layers | Set 1 | Set 2 | Set 3 | Conclusion |
| Antibacterial | 1 layer | 3B | 3B | 3B | 3B |
| coating | | | | | |

The hardness property of the antibacterial coatings of two and six coating layers were tested following ASTM D3363 standard. The property of hardness demonstrates that the hardness of the antibacterial coating of six coating layers was 3H as shown in Table 7. However, the hardness of the antibacterial coating of two coating layers was not consistent. This is because the antibacterial coating of two coating layers was too thin to deliver a consistent result on the hardness test.

TABLE 7

| | Number of | | | | |
|---|---|---|---|---|---|
| Sample | layers | Set 1 | Set 2 | Set 3 | Conclusion |
| Antibacterial | 6 layers | 3H | 3H | 3H | 3H |
| coating | 2 layers | 2H | B | 4B | Not |
| | | | | | consistent |

A test set up for investigating the bacteria killing rate is described as follows. A known concentration of bacteria (E. Coli.) was placed on keys of a keyboard with or without the antibacterial coating of the present invention for one hour. The bacteria were cultured overnight (until saturation) with nutrient medium, after 3-4 folds of dilutions, the bacteria were then applied on the keys with or without coating. After the bacteria were in contact with the keys at room temperature for one hour, the bacteria was collected and cultured on nutrient agar plates. Two types of the antibacterial coating including two and six coating layers were used. Three sets of experiment were conducted for each type of the antibacterial coating to result in three sets of data. The result is shown in Table 3.

TABLE 3

| | | | | Average | | E. Coli. |
|---|---|---|---|---|---|---|
| | E. Coli. | E. Coli. | E. Coli. | E. Coli. | | killing |
| | colonies | colonies | colonies | colonies | E. Coli. | percentage |
| Number | on keys | on keys | on keys | on keys | colonies | on keys with |
| of | with | with | with | with | on keys | coating |
| coating | coating | coating | coating | coating | with no | against |
| layer | Set 1 | Set 2 | Set 3 | Set 1 to 3 | coating | no coating |
| 2 | 8 | 0 | 0 | 3 | 220 | ~99% |
| Layers | | | | | | |
| 6 | 2 | 0 | 0 | 1 | | ~100% |
| Layers | | | | | | |

The numbers in the table from each set of the data are the colony numbers formed on the nutrient agar plates after 3 days of culture at 37° C. Both the antibacterial coatings of two and six coating layers killed at least 99% of the bacteria population when compared with the non-coated keys.

Apart from E. Coli, the antibacterial function of the antibacterial coating against Extended-Spectrum Beta Lactamase (ESBL) and Methicilin-Resistance Staphylococcus Aureus (MRSA) were also tested.

With the antibacterial coating of two coating layers, the average antibacterial effect to ESBL is higher than 99%, and the results are shown in Table 4.

TABLE 4

| | | | | | ESBL | |
|---|---|---|---|---|---|---|
| | ESBL growth on | | | Anti- | growth on | |
| | uncoated | | | bacterial | coated key | Antibacterial |
| | key (cfu/mL) | | Average | coating | (cfu/mL) | effect (%)# |
| Set 1 | A | 850000 | 863333 | A | 1000 | 98.84% |
| | B | 920000 | | B | 0 | 100.00% |
| | C | 820000 | | C | 2000 | 97.68% |
| | | | | Average | | 98.84% |
| Set 2 | A | 412000 | 470333 | A | 2000 | 99.57% |
| | B | 487000 | | B | 0 | 100.00% |
| | C | 512000 | | C | 3000 | 99.36% |
| | | | | Average | | 99.64% |
| Set 3 | A | 466000 | 459000 | A | 0 | 100.00% |
| | B | 522000 | | B | 0 | 100.00% |
| | C | 389000 | | C | 1000 | 99.78% |

| | |
|---|---|
| Average | 99.93% |

where cfu/mL denotes colony forming unit per 1 mL, and, the number indicates the amount of surviving bacteria remaining on the samples, and # denotes the percentage, which is the removal rate of the bacteria.

With the antibacterial coating of six coating layers, the average antibacterial effect to MRSA is higher than 60%, and the results are shown in Table 5.

TABLE 5

| | MRSA | | | | MRSA | |
|---|---|---|---|---|---|---|
| | growth on | | | | growth on | |
| | uncoated | | | Antibacterial | coated key | Antibacterial |
| | key (cfu/mL) | | Average | coating | (cfu/mL) | effect (%) |
| Set 1 | A | 68000 | 66333 | A | 23000 | 65.33% |
| | B | 70000 | | B | 23000 | 65.33% |
| | C | 61000 | | C | 26000 | 60.80% |
| | | | | Average | | 63.82% |
| Set 2 | A | 124000 | 104333 | A | 43000 | 58.79% |
| | B | 106000 | | B | 48000 | 53.99% |
| | C | 83000 | | C | 26000 | 75.08% |

| | |
|---|---|
| Average | 62.62% |

Accordingly, the antibacterial coating of the present invention is peel-resistant to water, 70% ethanol, 1:99 bleach solution and soap solution. The antibacterial coating is thin and transparent, and preferably less than 5 μm in thickness. The coating solution is under Restriction of Hazardous Substances Directive (RoHS) and Substances of Very High Concern (SVHC) compliant. The formulation of the coating solution is non-toxic, thus, it is safe for human use.

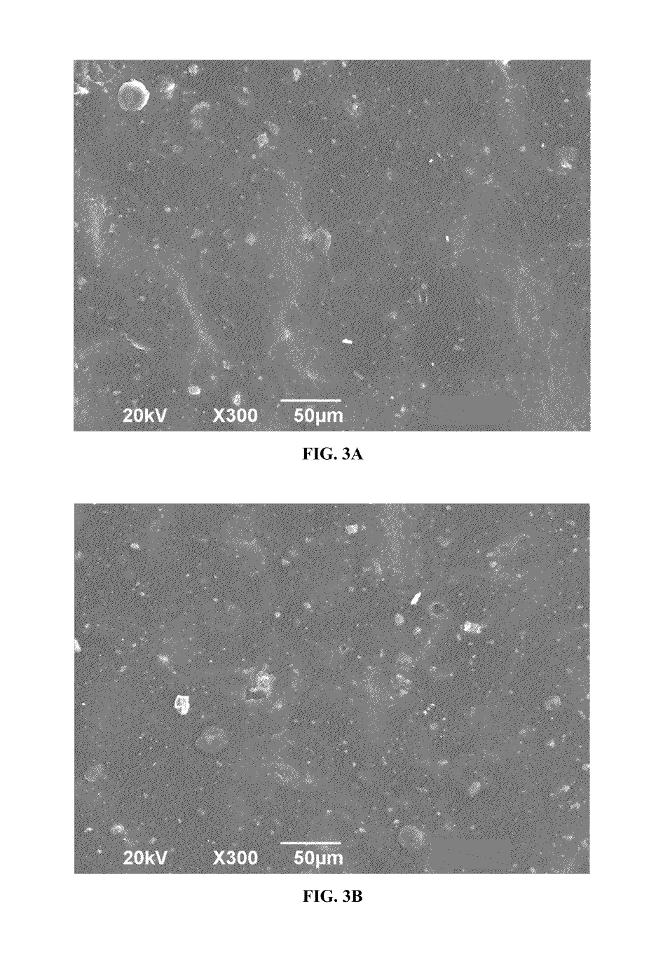

The resistant performance of the antibacterial coating with current disinfecting practice in a hospital was evaluated with a resistant simulation test. Keyboards were coated by the antibacterial coating of two coating layers, then rubbed with 1:99 diluted bleach solution for 15 times. This was to mimic the disinfecting practice in hospital more than 1 week by cleaning a keyboard for twice a day. The coating morphologies were examined and silver ion concentrations of the antibacterial coating were measured by scanned electron microscopy (SEM). FIG. 3A shows the SEM morphology of the antibacterial coating before rubbing with the diluted bleach solution. FIG. 3B shows the SEM morphology of the antibacterial coating after rubbing with the diluted bleach solution. As shown, the SEM morphologies of FIGS. 3A and 3B remain the same, thus indicating that the antibacterial coating is still present after rubbing, and the diluted bleach solution did not cause coating abrasion. Similarly, the average atomic concentrations of silver in percentage before and after rubbing were measured, and three points of silver concentration were measured by SEM to obtain the average value. The silver concentrations were plotted versus number of rubbing time to obtain the graph of FIG. 3C. As shown in FIG. 3C, the circular mark represents the Ag atomic concentration in the coating before rubbing, and the square mark represents that after rubbing. As seen, there is no measurable change for the average Ag atomic concentration after 15 times of rubbing with the diluted bleach solution when compared with that without rubbing.

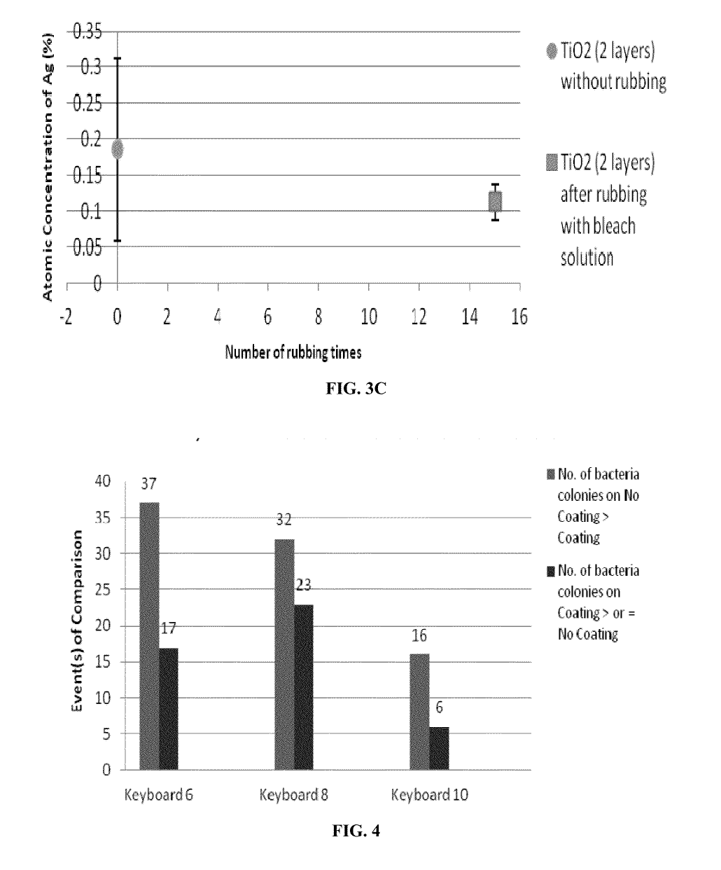

Onsite evaluation on comparison of total bacterial growth on coated and non-coated keys from three keyboards (No. 6, 8, and 10) tested in a hospital for 9 months was done. The coated keys were coated with the antibacterial coating of six coating layers. The three keyboards were placed at different locations in the hospital for staff use. The testing results are shown in FIG. 4. The bars in dark indicate the events that the numbers of total bacteria colonies on the non-coated keys were higher that of the coated keys. The bars in grey indicate the events that the numbers of total bacteria colonies on the coated keys were higher or equal to the non-coated keys. The comparisons were on daily basis. There were more events of higher bacterial counts on the non-coated keys than the coated keys. The data indicates the coating has antibacterial function for at least 9 months.

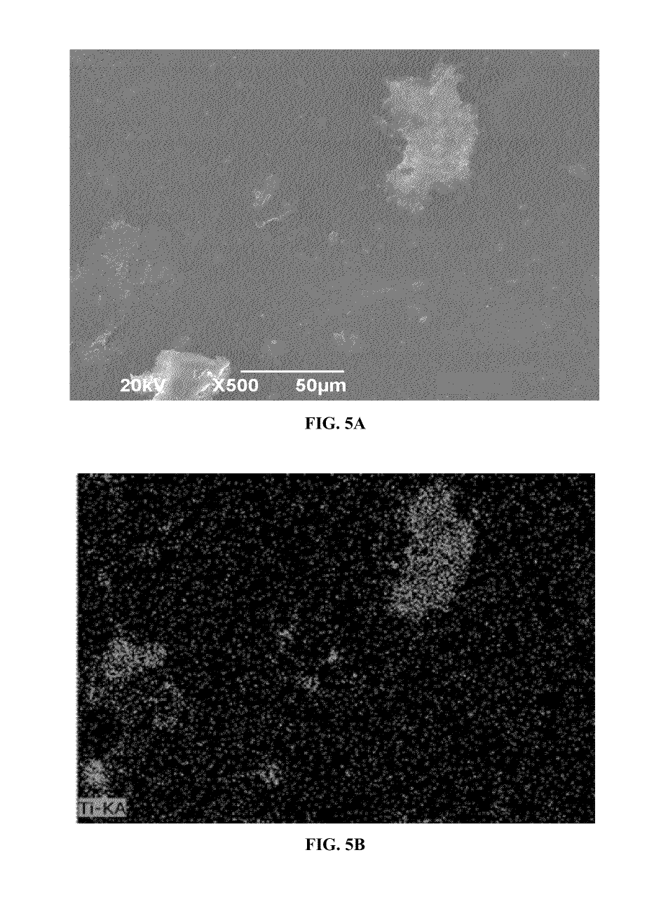

The coating morphology and titanium concentration were examined to evaluate the coating durability of TiO₂. The SEM morphology and titanium mapping of a keyboard (No. 6) coated with the antibacterial coating of six coating layers are shown in FIGS. 5A and 5B. The SEM morphology shows that the coatings are still present and detectable after 9 months of onsite usage. The titanium mapping indicates the presence of titanium in the coating through the areas of green fluorescence shown in FIG. 5B. Similarly, the SEM morphology and titanium mapping of another keyboard (No. 8) coated with the antibacterial coating of six coating layers are shown in FIGS. 5C and 5D, showing also the similar results. The positive values of the measured atomic concentration, as shown in Table 9, indicate that both titanium and silver are still present in the coatings after 9 months of usage.

TABLE 9

| | | | Atomic |
|---|---|---|---|
| Coating | Keyboard no. | Elements | concentration (%) |
| 6 layers | 6 | Titanium | 0.36 |
| | 6 | Silver | 0.03 |
| | 8 | Titanium | 0.04 |
| | 8 | Silver | 0.01 |

These results correlate well with the antibacterial effect of the antibacterial coating shown in FIG. 4. The coated keyboards are durable to deliver antibacterial function for at least 9 months.

The antibacterial functions of the antibacterial coating of two coating layers, coated on keyboards that had been used in a hospital for 1 year, were evaluated following the JIS Z 2807 standard. Three coated keyboards marked as K2, K3, and K11 were placed in three different locations in the hospital, and had been used for 1 year. Each of the coated keyboards was tested in triplicates. The coated keyboards had 100% antibacterial effect on the JIS test after 1 year of usage, and the results are shown in Table 8.

TABLE 8

| | | E. Coli. | | Antibacterial |
|---|---|---|---|---|
| Incubation | | growth | | removal rate |
| Time | Samples | (cfu/mL) | Average | (%) # |
| T = 0 hr | Uncoated key 1 | 250,000 | | |
| T = 0 hr | Uncoated key 2 | 280,000 | 276667 | N.A. |
| T = 0 hr | Uncoated key 3 | 300,000 | | |
| T = 24 hr | Uncoated key 1 | 11,000,000 | | |
| T = 24 hr | Uncoated key 2 | 23,000,000 | 20,000,000* | N.A. |
| T = 24 hr | Uncoated key 3 | 26,000,000 | | |
| T = 24 hr | K2-1 | 0 | | |
| T = 24 hr | K2-2 | 0 | 0 | 100% |
| T = 24 hr | K2-3 | 0 | | |
| T = 24 hr | K3-1 | 0 | | |
| T = 24 hr | K3-2 | 0 | 0 | 100% |
| T = 24 hr | K3-3 | 0 | | |
| T = 24 hr | K11-1 | 0 | | |
| T = 24 hr | K11-2 | 0 | 0 | 100% |
| T = 24 hr | K11-3 | 0 | | |

where # denotes the percentage of the removal rate of the bacteria, and *denotes increased >7200% compared to T = 0 hr.

Various coating solutions of the present invention were prepared in different percentage of silver nitrate (w/v%) using the method of Example 1, and antibacterial coatings of two coating layers formed by different coating solutions were tested for bacteria killing rate. Table 10 shows the bacteria killing rate with different concentrations of silver nitrate applied in the coating solution.

TABLE 10

| Concentration of | Bacteria | Original | Concentration of E. |
|---|---|---|---|
| silver nitrate in the | (E. Coli.) | concentration of | Coli. on the |
| coating solution | killing rate | E. Coli. solution | keyboard surface |
| (w/v %) | (after 3 h) | (cfu) | (cfu) |
| 0.25% | 87.3% | 140000 | 17800 |
| 0.1% | 93.1% | 140000 | 9600 |
| 0.05% | 74.1% | 140000 | 36200 |
| 0.025% | 52.9% | 140000 | 66000 |
| 0.005% | 15.7% | 140000 | 118000 |

The 0.1% (w/v) of silver nitrate used in the coating solution shows the best bacteria (E. Coli.) killing rate. Preferably, 0.025-0.25% (w/v) of silver nitrate can be employed as well.

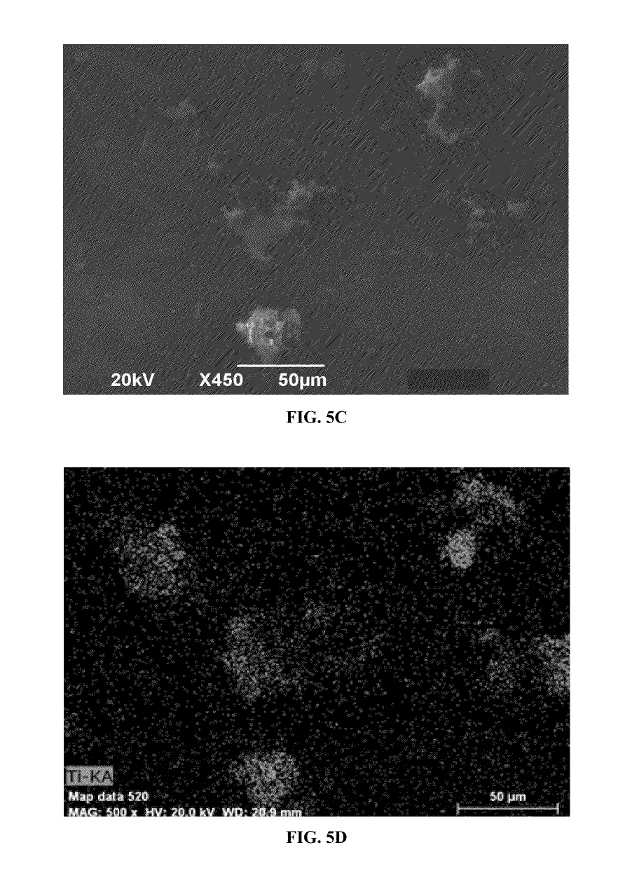

According to various embodiments of the presently claimed invention, the preferable range of concentration of titanium tetraisopropoxide in the antibacterial coating solution is from 1% to 10% (v/v). FIG. 6 show appearances of keys on a keyboard with the antibacterial coatings formed from different percentages of titanium tetraisopropoxide including 1%, 2.5%, 5%, and 10% (v/v), and 2.5% (v/v) of titanium tetraisopropoxide is the best among others to deliver a transparent and strong enough coating .

Table 11 shows a table of molar ratio of Ag to Ti.

TABLE 11

| | Silver Nitrate | Titanium Tetraisopropoxide Concentration | | | |
|---|---|---|---|---|---|
| | Concentration | (v/v %) | | | |
| | (w/v % ) | 1% | 2.5% | 5% | 10% |
| | 0.25% | 0.408 | 0.163 | 0.0815 | 0.0408 |
| | 0.10% | 0.163 | 0.0652 | 0.0326 | 0.0163 |
| | 0.05% | 0.0815 | 0.0326 | 0.0163 | 0.00815 |
| | 0.025% | 0.04075 | 0.0163 | 0.00815 | 0.00408 |
| | 0.005% | 0.00815 | 0.00326 | 0.00163 | 0.000815 |
| Molar | Upper limit | 0.408:1 | 0.163:1 | 0.0815:1 | 0.0408:1 |
| Ratio | Lower limit | 0.00815:1 | 0.00326:1 | 0.00163:1 | 0.000815:1 |
| (Ag:Ti) | | | | | |

Accordingly, the preferable range of molar ratio of Ag to Ti is from 0.00408:1 to 0.163:1. More particularly, the preferable range of molar ratio of Ag to Ti is from 0.0163:1 to 0.163:1 since 0.1% (w/v) of silver nitrate shows the best bacterial killing rate. The preferable molar ratio of Ag to Ti is 0.0652:1 because 2.5% (v/v) of titanium tetraisopropoxide is the best among others to deliver a transparent, durable and strong enough coating.

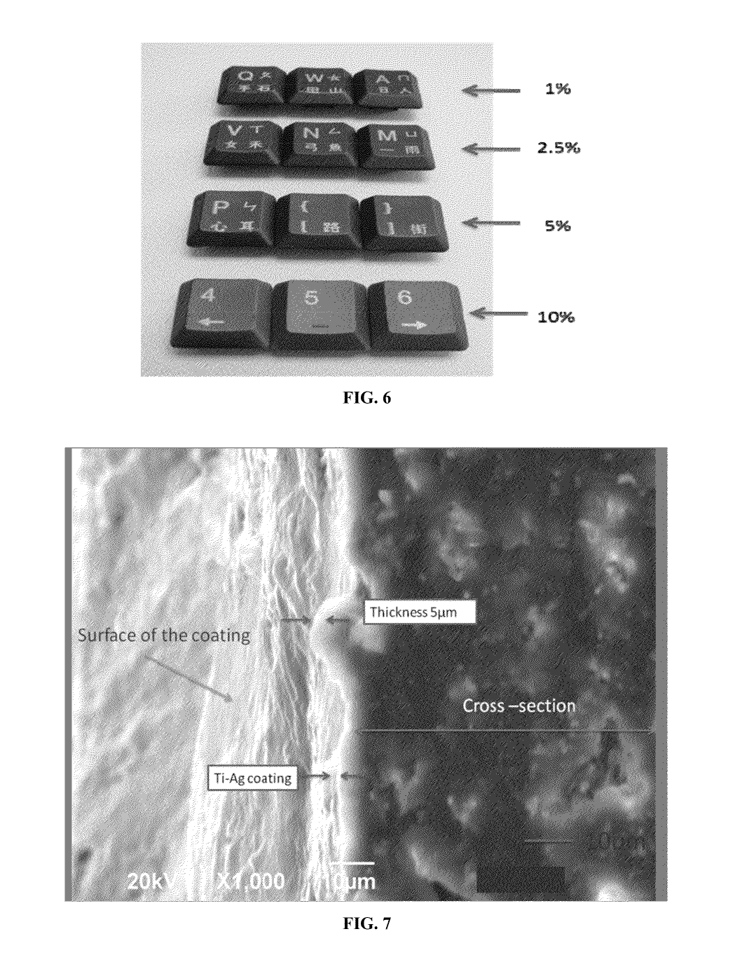

According to one embodiment of the presently claimed invention, SEM morphology of an antibacterial coating with ten coating layers is shown in FIG. 7. The thickness of the antibacterial coating is around 5 μm.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A durable, germicide-free and antibacterial coating formed by a coating solution, said coating solution comprising ethanol, nitric acid, 1%-10% (v/v) of titanium tetraisopropoxide, water, and 0.025%-0.25% (w/v) silver nitrate, and said coating solution being prepared by: hydrolyzing titanium tetraisopropoxide into water with addition of an acid to form white precipitates; stirring the white precipitates to obtain a titanium dioxide (TiO₂) solution with a first pH from 1 to 2; putting the TiO₂ solution into a porous dialysis membrane tube to dialyze the TiO₂ solution in water until a second pH of the TiO₂ solution reaches between 3 and 4 to form a first solution; dissolving silver nitrate into water to form a second solution; and mixing the first solution, the second solution and ethanol together to form the coating solution, and said coating being formed by: applying the coating solution by spraying, spreading or dipping onto at least a surface of an object to form one or more coating layers; drying the one or more coating layers with a curing temperature in a range from 80 to 300° C. and at a drying rate from 4 to 30 min per coating layer to form the coating with a thickness of each layer from 0.5 to 5 μm and with a number of the coating layers from 2 to 10, and said coating being configured to be peel-resistant to water, ethanol, beach solution, or soap solution, with an adhesion of 3B following ASTM D3359 standard and hardness of 3H following ASTM D3363 standard.

2. A method for synthesizing a coating solution for a durable, germicide-free and antibacterial coating, said method comprising the steps of:
hydrolyzing titanium tetraisopropoxide into water with addition of an acid to form white precipitates;
stirring the white precipitates to obtain a titanium dioxide (TiO₂) solution with a first pH from 1 to 2;
putting the TiO₂ solution into a porous dialysis membrane tube to dialyze the TiO₂ solution in water, until a second pH of the TiO₂ solution reaches between 3 and 4 to form a first solution;
dissolving silver nitrate into water to form a second solution; and
mixing the first solution, the second solution and ethanol together to form the coating solution.

3. The method of claim 2, wherein the coating solution comprises 0.025%-0.25% (w/v) of silver nitrate.

4. The method of claim 2, wherein the coating solution comprises 0.1% (w/v) of silver nitrate.

5. The method of claim 2, wherein the coating solution comprises 1% -10% (v/v) of titanium tetraisopropoxide.

6. The method of claim 2, wherein the coating solution comprises a molar ratio of silver to titanium in a range of 0.00408:1 to 0.163:1.

7. A coating solution for a durable, germicide-free and antibacterial coating prepared by the method of claim 2, wherein the coating solution comprises 0.025%-0.25% (w/v) of silver nitrate.

8. The coating solution of claim 7, wherein concentration of said silver nitrate in said solution is 0.1% (w/v).

9. The coating solution of claim 7, wherein the coating solution comprises a molar ratio of silver to titanium in a range of 0.00408:1 to 0.163:1.

10. A method for forming a durable, germicide-free and antibacterial coating on an object, said method comprising the steps of:
preparing a coating solution according to the method of claim 1;
providing the object;
applying the coating solution onto at least a surface of the object to form one or more coating layers; and
drying the one or more coating layers with a curing temperature in a range from 80 to 300° C. to form the coating.

11. The method of claim 10, wherein the one or more coating layers are dried at a drying rate from 4 to 30 min per coating layer.

12. The method of claim 10, wherein the one or more coating layers are dried in an oven.

13. The method of claim 10, wherein each of the one or more coating layers has a thickness from 0.5 to 5 μm.

14. The method of claim 10, wherein the number of the one or more coating layers is in a range from 2 to 10.

15. The method of claim 10, wherein the coating solution is applied onto the surface of the object by spraying, spreading or dipping.

16. The method of claim 15, wherein the spraying is applied by a spray gun.

17. A durable, germicide-free and antibacterial coating formed by the method of claim 10.

18. The coating of claim 17, wherein thickness of the coating is less than 5 μm.

19. The coating of claim 17, wherein the coating is peel-resistant to water, ethanol, beach solution, or soap solution.

20. The coating of claim 17, wherein adhesion of the coating is 3B following ASTM D3359 standard, or hardness of the coating is 3H following ASTM D3363 standard.
